(19) United States
(12) Patent Application Publication
(10) Pub. No.: US 2025/0348764 A1
(43) Pub. Date: Nov. 13, 2025

(54) SYSTEMS, METHODS, AND NON-TRANSITORY COMPUTER-READABLE STORAGE MEDIA FOR GENERATING REASONING GRAPHS

(71) Applicant: Applied Enterprise Management Corporation, Herndon, VA (US)

(72) Inventors: Stephan Lemmer, Duvall, WA (US); Mathew Morgan, El Segundo, CA (US); Mark Zebley, Rogers, AR (US)

(21) Appl. No.: 18/661,281

(22) Filed: May 10, 2024

(51) Int. Cl. G06N 5/04

(52) U.S. Cl. CPC G06N 5/04

(57) ABSTRACT

A networked computer system for generating Reasoning Graphs is described herein. The networked computer system includes a data storage server storing a data source including information associated with a plurality of evidence documents and a data analysis computer server including one or more data analysis processors coupled to the data storage server and to an artificial intelligence (AI) computer system. The one or more data analysis processors programmed to execute an algorithm including the steps of querying the AI computer system to determine one or more entry-level answers based on the extracted evidence from the plurality of evidence documents and generating a reasoning graph data structure by determining a corresponding confidence score associated with each entry-level answer and identifying a corresponding evidence document used in determining each entry-level answer.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### FIELD OF THE DISCLOSURE

The present invention relates to networked computer, and more particularly, to systems, methods, and computer-readable storage media for operating a networked computer system including one or more processors programmed to generate Reasoning Graphs.

### BACKGROUND

At least some known artificial intelligence (AI) computer systems include Large Language Models (LLMs) that are often proposed for unstructured text analyses due to their apparent ability to perform complex high-level reasoning tasks using memorized facts. However, when such models are used, they are susceptible to hallucinations, where they confidently produce an answer that is not aligned with the given context. Despite this challenge, assessing the confidence of a neural model is a well-studied problem in general: classifiers (where the answer is chosen from a set of potential answers) produce a distribution across potential outputs. This means that a model trained to classify between pictures of cats, dogs, and pigs, does not output a single guess (cat), but instead outputs a distribution like 90% cat, 7% dog, 3% pig. Many models are built as a classifier, which provides confidence-aware guesses to the interpretation of source data into the reasoning graph. LLMs can be categorized as classifiers: given a string of words they predict the probability of each potential next word. While the next-word confidences have been shown to be calibrated in some settings, using them is a meaningful technical challenge for three reasons: It is not immediately clear which tokens are important (for example, the difference between February and March is meaningful, but the difference between born on and birthdate is is not); There are multiple ways to express the same fact, and the uncertainty may reflect multiple expressions of the same information (For example, February and 2 represent the same information, but could both have the confidence 50%); and Commercial APIs typically do not provide access to logit-level confidences. Current SOTA approaches address these challenges by generating several samples and measuring the similarity of the samples. For example: SelfCheckGPT, Semantic Uncertainty, and BSDetector. While these are reasonable black-box approaches (that is, they don't have access to the model's intermediate calculations), there are shortcomings as it relates to our problem. The general assumption is of a free-form natural language output, generally broken into e.g., sentences that reflect independent facts. This motivates the use of Natural Language Inference (NLI) similarity measures or sampled LLM calls which, as probabilistic learned classifiers, are subject to failure. While we may require such techniques in some cases, most of our answers are not complete sentences and can be trivially matched using string or number matching techniques. Additionally, such techniques typically focus on detecting falsehoods when information is drawn from parametric knowledge, things learned by the model instead of those told to the model in the prompt (such as in the Retrieval Augmented Generation framework).

The present invention is aimed at one or more of the problems identified above.

### SUMMARY OF THE INVENTION

In one aspect of the present invention, a networked computer system is provided. The networked computer system includes a data storage server storing a data source including information associated with a plurality of evidence documents and a data analysis computer server including one or more data analysis processors coupled to the data storage server and to an artificial intelligence (AI) computer system. The one or more data analysis processors programmed to execute an algorithm including the steps of: rendering a data analysis input screen on a display device of a user computing device including a research question input prompt, receiving a research question from a user via the research question input prompt, querying the AI computer system to establish a question decomposition data structure including a plurality of decomposed questions based on the received research question, querying the AI computer system to extract evidence from the plurality of evidence documents included in the data source based on the plurality of decomposed questions, querying the AI computer system to determine one or more entry-level answers associated with each decomposed question based on the extracted evidence from the plurality of evidence documents, querying the AI computer system to select one or more evidence documents associated with the one or more entry-level answers, generating a reasoning graph data structure by determining a corresponding confidence score associated with each entry-level answer and identifying a corresponding evidence document used in determining each entry-level answer, generating a final answer to the research question based on the reasoning graph data structure, and rendering a data analysis results screen on the display device displaying the final answer, the one or more entry-level answers, and information included in the reasoning graph data structure including the corresponding confidence score and the corresponding evidence document associated with each entry-level answer.

In another aspect of the present invention, a method of operating a networked computer system including a data storage server storing a data source including information associated with a plurality of evidence documents, and a data analysis computer server including one or more data analysis processors coupled to the data storage server and to an artificial intelligence (AI) computer system is provided. The method includes the one or more data analysis processors performing an algorithm including the steps of: rendering a data analysis input screen on a display device of a user computing device, the data analysis input screen including a research question input prompt, receiving a research question from a user via the research question input prompt, querying the AI computer system to establish a question decomposition data structure including a plurality of decomposed questions based on the received research question, querying the AI computer system to extract evidence from the plurality of evidence documents included in the data source based on the plurality of decomposed questions, querying the AI computer system to determine one or more entry-level answers associated with each decomposed question based on the extracted evidence from the plurality of evidence documents, querying the AI computer system to select one or more evidence documents associated with the one or more entry-level answers, generating a reasoning graph data structure by determining a corresponding confidence score associated with each entry-level answer and identifying a corresponding evidence document used in determining each entry-level answer, generating a final answer to the research question based on the reasoning graph data structure, and rendering a data analysis results screen on the display device displaying the final answer, the one or more entry-level answers, and information included in the reasoning graph data structure including the corresponding confidence score and the corresponding evidence document associated with each entry-level answer.

In yet another aspect of the present invention, one or more non-transitory computer-readable storage media, having computer-executable instructions embodied thereon to operate a networked computer system including a data storage server storing a data source including information associated with a plurality of evidence documents, and a data analysis computer server including one or more data analysis processors coupled to the data storage server and to an artificial intelligence (AI) computer system. When executed by the one or more data analysis processors the computer-executable instructions cause the one or more data analysis processors to perform an algorithm including the steps of: rendering a data analysis input screen on a display device of a user computing device, the data analysis input screen including a research question input prompt, receiving a research question from a user via the research question input prompt, querying the AI computer system to establish a question decomposition data structure including a plurality of decomposed questions based on the received research question, querying the AI computer system to extract evidence from the plurality of evidence documents included in the data source based on the plurality of decomposed questions, querying the AI computer system to determine one or more entry-level answers associated with each decomposed question based on the extracted evidence from the plurality of evidence documents, querying the AI computer system to select one or more evidence documents associated with the one or more entry-level answers, generating a reasoning graph data structure by determining a corresponding confidence score associated with each entry-level answer and identifying a corresponding evidence document used in determining each entry-level answer, generating a final answer to the research question based on the reasoning graph data structure, and rendering a data analysis results screen on the display device displaying the final answer, the one or more entry-level answers, and information included in the reasoning graph data structure including the corresponding confidence score and the corresponding evidence document associated with each entry-level answer.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a networked computer system for use in generating Reasoning Graphs used with AI computer systems, according to embodiments of the present invention;

FIG. 2 is a flowchart illustrating an algorithm executed by the networked computer system for use in generating Reasoning Graphs, according to embodiments of the present invention;

FIG. 3 is a schematic illustration of exemplary Question Decomposition data structure generated by the networked computer system using the algorithm shown in FIG. 2, according to embodiments of the present invention;

FIGS. 4-7 are schematic illustrations of exemplary Reasoning Graph data structures generated by the networked computer system using the algorithm shown in FIG. 2, according to embodiments of the present invention;

FIGS. 8-9 are schematic illustrations of exemplary Evidence Graph data structures generated by the networked computer system using the algorithm shown in FIG. 2, according to embodiments of the present invention; and

FIGS. 10-16 are illustrations of a sequence of graphical computer images displaying exemplary graphical user interface screens that may be displayed on user computing devices, according to embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

With reference to the figures and in operation, the present invention provides a networked computer system, methods and non-transitory computer-readable storage media for use in generating reasoning graphs for use in improving the use of AI computer systems. The Reasoning Graph involves several discrete but complementary innovations: generation of a structured, step-by-step approach required for the analysis of a set of records; a combination of sampling-based and deterministic methods for calculating confidence levels at every step as the analysis is performed by the software program; and checks for hallucinations with the initial evidence extraction and throughout the subsequent reasoning chain.

The system provides specific features of “data analyst copilot” product (such as prioritizing specific, lower-confidence analysis for manual review) by generating a reasoning graph that is a record of all the steps and processing required to provide a specific, requested analysis. Questions are answered of individual entities, then aggregated through a variety of mathematical and statistical processes until a final answer is reached.

For example, a reasoning graph across two evidence documents (e.g., shown as “APR”) for the question how many grants will be active in 2027? is shown in FIG. 4. This structured reasoning graph has three main benefits: detecting hallucinations and tracking provenance; tracking confidence to detect low-quality inference and guide interventions; and efficiently enabling analyst intervention. By decomposing the reasoning process into individual steps, the system can automatically remove hallucinated evidence via string matching and track the effect of any piece of evidence through the reasoning system. This ability to track evidence means that the user/analyst can examine in context the information that was used to generate an answer.

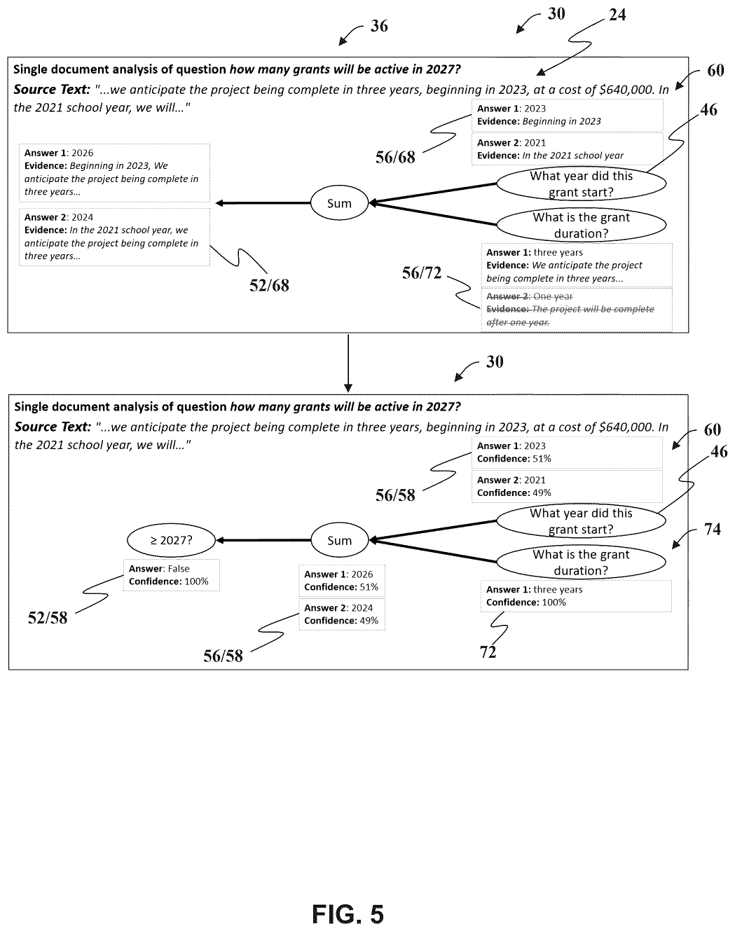

For example, as shown in FIG. 5 illustrating a single-document analysis with an AI computer system including an LLM, the LLM hallucinates evidence providing the answer “one year” to the question “what is the grant duration?”, but it can be immediately and/or automatically removed because it can't be found in the context. Additionally, since the evidence is directly mapped to both the answer and its location in the document, a user/analyst can check for appropriate interpretation of the evidence. Specifically: why are 2023 and 2021 both valid answers?

Propagating Confidence and Guiding Interventions: As the LLM analysis scales, it becomes impractical to manually investigate answers and locate evidence. Instead, the system directs the user/analyst to the best place to intervene. Referring to FIG. 5, confidence values are displayed instead of evidence (both are maintained in the reasoning graph at all times): There are two things to note here: first, the reasoning graph is able to identify that the model is unsure about the grant's start year. Second, both options will result in the same final answer. For this reason, while the analyst could be guided to the individual low-confidence nodes, the reasoning graph can recognize that this will not change the final answer, and therefore will direct the analyst to other locations where their efforts will be more useful.

For example, all information used by the system is sourced from the document, explicitly checked as evidence, and passed on to the answering component (see Provenance Tracking and Hallucination Detection). Because of this, the system samples across multiple answers and reasoning paths, and also multiple evidence sets. In other words, if a document contains two sentences that provide conflicting answers the answering model may generate sampled answers using each sentence individually, resulting in two sets of answers that agree with themselves but disagree with each other, as well as both together, resulting in one set of answers that disagrees with itself. All three of these are combined to produce a confidence calculation.

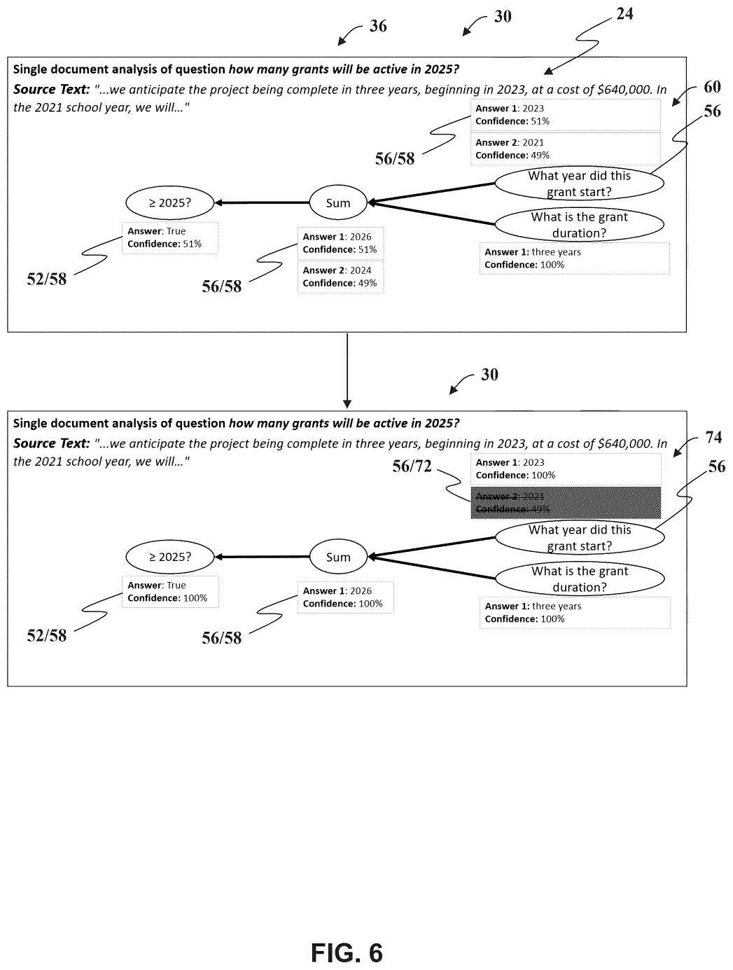

Updating Inferences: Not only does the reasoning graph allow the system to identify low-confidence inferences and their downstream effects, but it allows the system to integrate the analyst's knowledge to perform a targeted update of the final answer. For example, as shown in FIG. 6, consider a version of the running example where we want to know how many grants will be active in 2025 instead of 2027: Since the final output is low confidence, the system allows the user/analyst to directly inspect the document to manually answer to the question what year did the grant start? and decides that 2023 is correct. That information is automatically propagated through the sum and greater than operations as shown in FIG. 6. Note that the question what is the grant duration? did not need to be modified. Similarly, referring to FIG. 5, for the full process, the upstream summation would also be re-calculated, but no additional processing would be performed on branches related to other evidence documents.

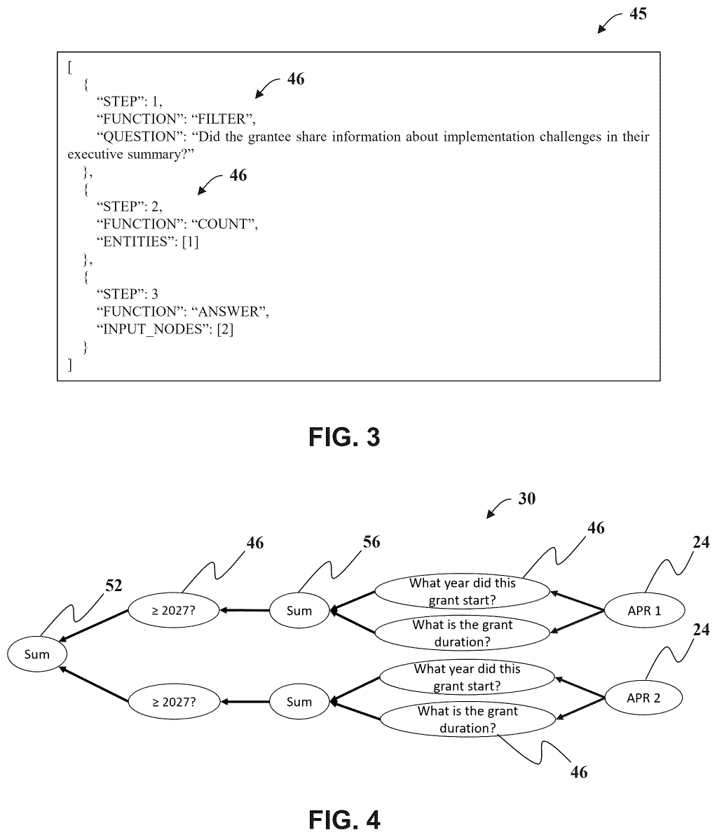

Creating the Reasoning Graph: Reasoning graphs are generated as a series of well-defined steps and functions. In some embodiments, the LLM generates an initial set of steps (e.g., a question decomposition data structure shown in FIG. 3), and the reasoning graph is created based upon not only the steps, but sub-steps that those steps take and decisions made by LLM-based and non-LLM-based modules. Typically, when invoking external functions—accessing data the LLM can't access or doing calculations that an LLM finds challenging—it is done by inserting “function calls” into a conversation. For example, if the user asks “where can I find a taco truck?”, the LLM will generate a JSON request to search Yelp for taco trucks, and the surrounding code will execute this search. Both the initial JSON request and the function's response are added to the conversation, and the model outputs a natural language answer or another function call based on this information.

This may be acceptable when the interface is a conversation and the model is unlikely to call functions in sequence, but it is challenging for the analysis framework: first, the calls and returns of larger reasoning graphs may exceed the context window, since parameters need to be included in the function call and response and some of our use cases include several thousand documents. Second, it is more challenging to enforce provenance checks: since the function call paradigm has the LLM populate the parameters, hallucinations can occur anywhere in the reasoning graph, including the questions themselves, and must be manually checked at every node via string or numeric matching. Last, the model can reach a dead-end or provide procedures that cannot be executed.

In contrast, the steps required to solve a problem will typically be independent of the responses to those steps. In other words, if the user asks “How many grantees shared information about challenges in their executive summaries?”, the process will be: 1) identify entities that shared challenges, 2) count the number of entities, regardless of how the questions are answered.

A formatted response to the question is shown in FIG. 3 including a question decomposition data structure: Question: How many grantees shared information about implementation challenges in their executive summaries? This example illustrates how the challenges of the standard approach are addressed: the context remains short, since it only requires pointers to previous steps (“ENTITIES” and “INPUT_NODES” reference “STEP”). Similarly, since the arguments are never given to the LLM, the system can trivially track provenance. For the last challenge—the risk of running into dead-ends or invalid logic paths—the method does not fully eliminate this possibility, but it does allow manual guardrails. For example: the system can check that the final function is always ANSWER, and that every step's input has been given by a previous step (i.e., the input exists)

Further, since the full plan is generated at once, the system can sample in a manner similar to the one described in Calculation of Model Confidence for Reasoning Graph. As when interpreting documents, this will allow the system to calculate the confidence in a plan, improve performance via self-consistency (where allowing multiple thought processes increases the probability of a correct answer), and allow the system to eliminate impossible reasoning graphs without needing to generate new ones (a slow procedure requiring more complex logic).

This decomposition process is a way to convert high-level aggregate questions to a procedure that can be performed across many entities. It is noted that this is not the only place that decompositions will occur. Answering questions related to single documents will often require multi-hop reasoning, which occurs when the question can't be directly answered from the source material. For example, in FIG. 5, the end year of the grant is not directly available in the document, so the model determines the duration and start date of the grant, and sums them together.

For clarity in discussing the various functions of the networked computer system 10, multiple computers and/or servers are discussed as performing different functions. These different computers (or servers) may, however, be implemented in multiple different ways such as modules within a single computer. The functions performed by the networked computer system 10 may be centralized or distributed in any suitable manner across the networked computer system 10 and its components, regardless of the location of specific hardware. Furthermore, specific components of the networked computer system 10 may be referenced using functional terminology in their names. The function terminology is used solely for purposes of naming convention and to distinguish one element from another in the following discussion. Unless otherwise specified, the name of an element conveys no specific functionality to the element or component.

In the illustrated embodiment, the networked computer system 10 includes a data analysis computer server 12 that is coupled in communication with a data storage server 14, an artificial intelligence (AI) computer system 15, a website hosting server 16, and a plurality of user computing devices 18 via a communications network 20. The communications network 20 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed.

Each computer system and/or server may include one or more server computers that each include a processing device that includes a processor that is coupled to a memory device. The processing device executes various programs, and thereby controls components of the server according to user instructions received from the user computing devices 18 and/or other servers. The processing device may include memory, e.g., read only memory (ROM) and random access memory (RAM), storing processor-executable instructions and one or more processors that execute the processor-executable instructions.

Each user computing device 18 includes a display device for rendering computer-generated graphics and a processing device that includes a processor that is coupled to a memory device. The processing device executes various programs, and thereby controls components of the computing device according to user instructions received by the user to enable the user to access and communicate with the networked computer system 10 including sending and/or receiving information to and from the networked computer system 10 and displaying information received from the system 10 to the user.

For example, in some embodiments, the user computing device 18 may include, but is not limited to, a desktop computer, a laptop or notebook computer, a tablet computer, smartphone/tablet computer hybrid, a personal data assistant, a handheld mobile device including a cellular telephone, and the like. In addition, the user computing device 18 may include a touchscreen that operates as the display device and the user input device. In the illustrated embodiment, the user computing device 18 includes a web-browser program that is stored in the memory device. When executed by the processor of the user computing device, the web-browser program enables the user computing device 18 to receive software code from the website hosting server 16 including, but not limited to HTML, JavaScript, and/or any suitable programming code that enables the user computing device to generate and display a website and/or webpages on the display device of the user computing device 18. The web-browser program also enables the user computing device 18 to receive instructions from the website hosting server 16 that enable the user computing device 18 to render HTML code for use in generating and displaying portions of the website and/or webpage.

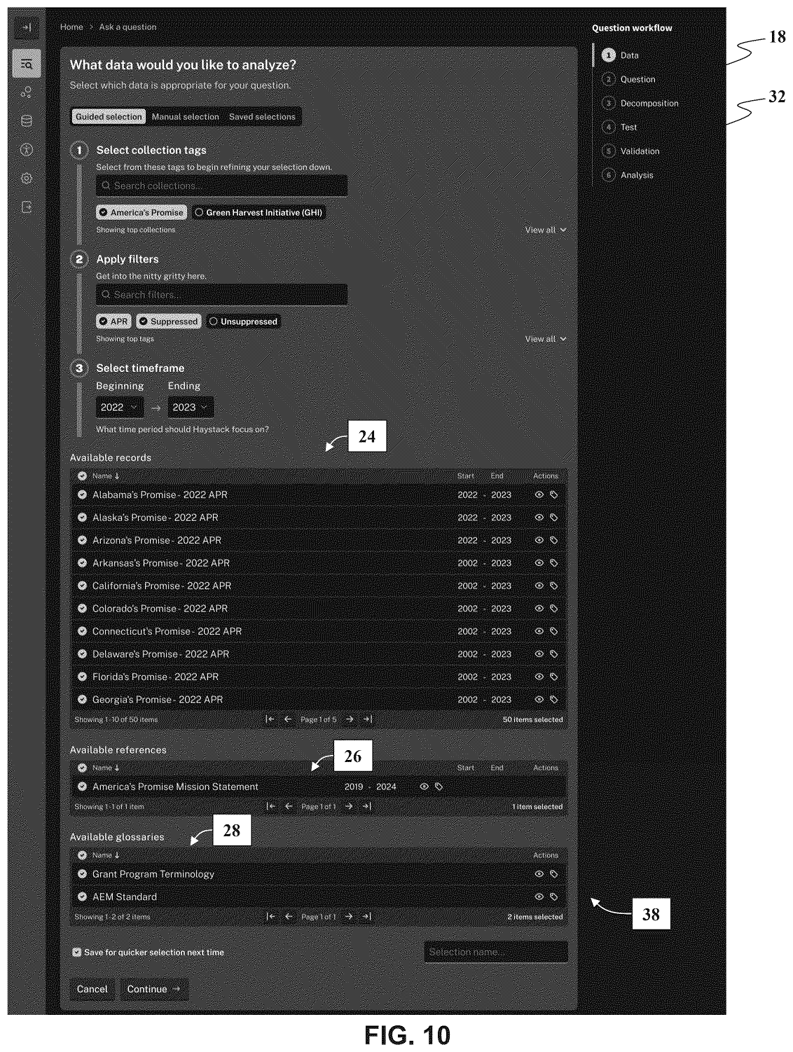

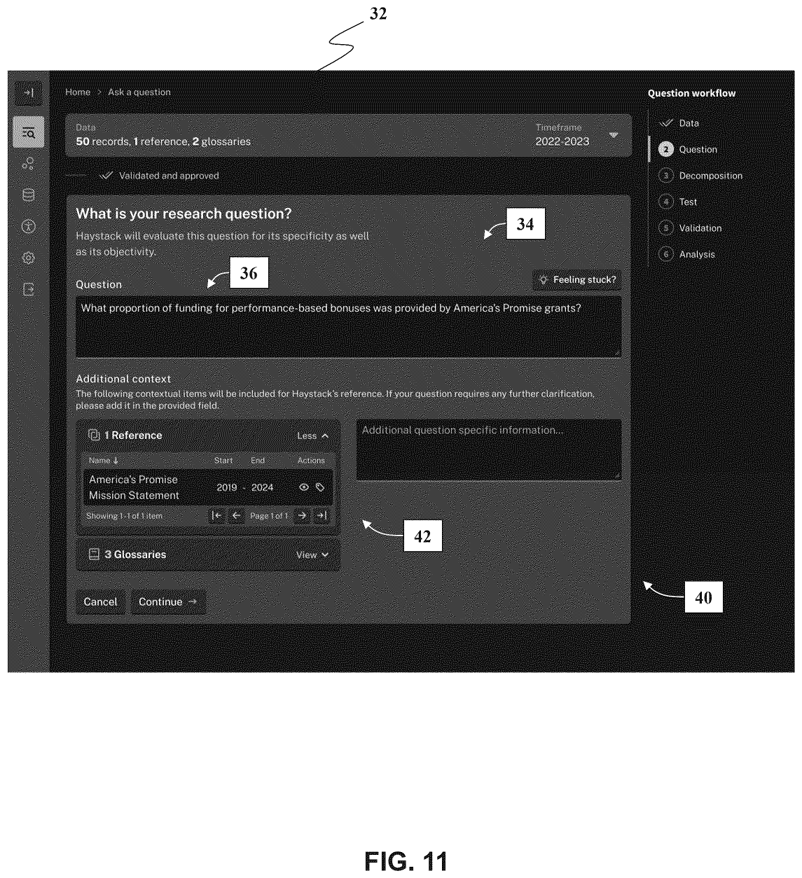

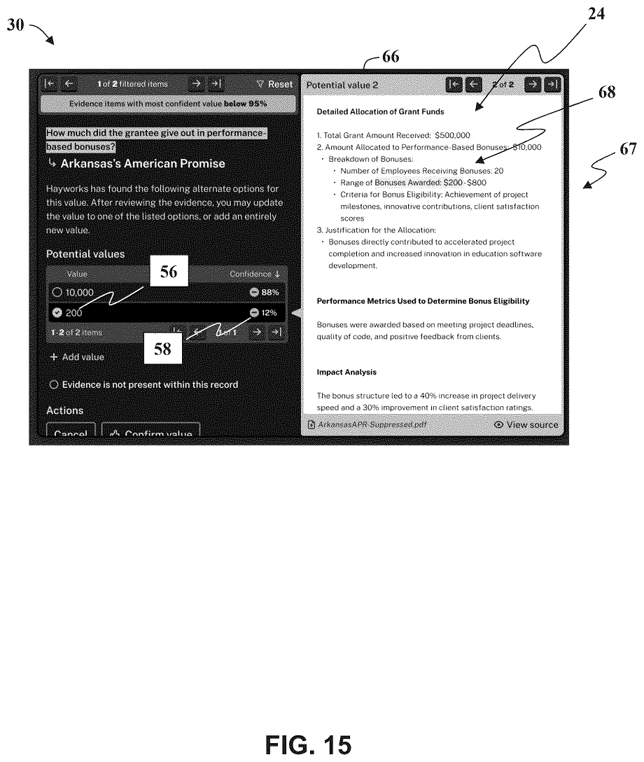

The website hosting server 16 is programmed to host a website including webpages (shown in FIGS. 10-16) that is accessible by a user via one or more user computing devices 18. The website hosting server 16 executes a website application program that retrieves application code being stored in the data storage server 14 and executes the application code including the software components to render one or more webpages on a display device of a user computing device 18 in response to requests received from the user via the user computing device 18 to allow users to interact with the website.

The AI computer system 15 includes one or more processors programmed to implement deep learning neural networks and/or machine learning models such as, for example, Large Language Models (LLMs) that are trained to analyze information stored in the data storage server 14, recognize and interpret human language or other types of complex data, and generate human-like text responses to questions presented by users via the webpages. In some embodiments, the AI computer system 15 may include one or more processors programmed to implement Transformer Model, Attention Model, Recurrent neural network (RNN) model, Long short-term memory (LSTM) model, Gated recurrent units (GRUs), Convolutional neural network (CNN), or similar.

The data analysis computer server 12 includes one or more data analysis processors configured to perform operations to support the functions of the webpages and/or website being displayed by the website hosting server 16.

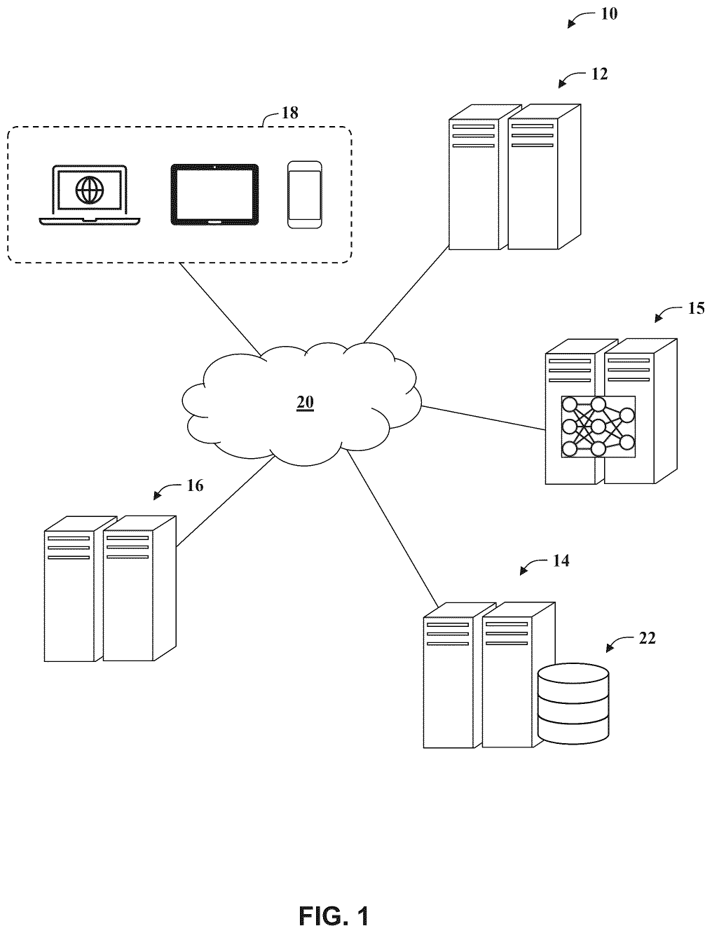

The data storage server 14 stores information and data used by the AI computer system 15 and the data analysis computer server 12 to analyze questions presented by users and provide human-like text responses to those questions. For example, as shown in FIGS. 1 and 10, in some embodiments, the data storage server 14 includes a data source 22 that includes information associated with a plurality of evidence documents 24, one or more reference materials 26, and one or more glossaries 28, that may be used by the AI computer system 15 to interpret the questions presented by users, analyze the information included in the data source 22, and generate answers.

In some embodiments, the data analysis computer server 12 may query the AI computer system 15 to perform specific tasks including: generating an initial question decomposition plan (shown in FIG. 3), and once the plan is generated, it exists as JSON and the LLM instance is discarded, with steps that may be added to the plan by non-LLM components; Extracting evidence from individual documents; Turning extracted evidence into entity-level answers; and/or Choosing the document that is most likely to have an answer. In other embodiments, any or all of the above-reference tasks may be performed with a non-LLM approach while maintaining the fundamental innovations of the reasoning graph.

The data analysis computer server 12 may also perform tasks including rendering the interface, enabling user interaction (manipulating or exploring the reasoning graph), though another embodiment may use an LLM to translate natural language commands into a programmatic request that can be executed on the reasoning graph, generating the confidence score (when an LLM is involved, the confidence can be thought of as an operation applied to the LLM output), and/or generating the reasoning graph.

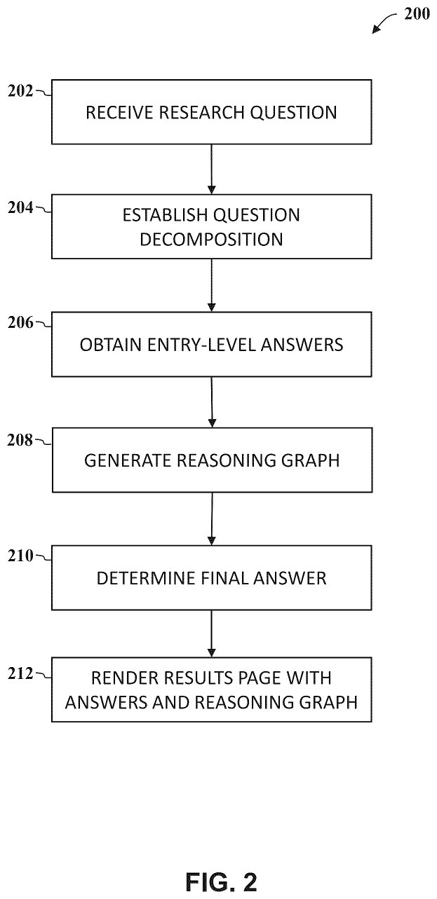

FIG. 2 is a flowchart illustrating an algorithm 200 executed by the data analysis computer server 12 for use in generating Reasoning Graphs. FIGS. 4-9 are illustrations of exemplary reasoning graph data structures 30 generated by the data analysis computer server 12 when performing the algorithm 200. FIGS. 10-16 are illustrations of sequences of graphical computer images displaying exemplary graphical user interface screens and/or windows rendered by the website hosting server 16 based on computer-instructions provided by the data analysis computer server 12 and displayed on the display devices of the user computing devices 18.

The algorithm 200 includes a plurality of steps. Each algorithm step may be performed independently of, or in combination with, other algorithm steps. Portions of the algorithm may be performed by any one of, or any combination of, the components of the system 10.

In the illustrated embodiment, in method step 202, the data analysis processor of the data analysis computer server 12 receives a research question from a user via a user computing device 18. For example, as shown in FIGS. 10-16, in some embodiments, the data analysis processor may prompt the website hosting server 16 to render a data analysis input screen 32 on a display device of the user computing device 18. The data analysis input screen 32 includes a research question input prompt 34 to allow the user to input one or more research questions 36 in natural language text. The data analysis processor may also be programmed to render the data analysis input screen 32 to include a data analysis selection window 38 that displays the information included in the data source 22 and allow the user to select the information used by the data analysis processor in analyzing and generating answers to the research question presented by the user. For example, the data analysis processor may render the data analysis selection window 38 to display user selectable icons associated with the one or more evidence documents 24 that may be used by the data analysis processor and/or the AI computer system 15 in answering the user presented research question, one or more reference materials 26 that may be used by the data analysis processor and/or the AI computer system 15 in analyzing the evidence documents 24, and one or more glossaries 28 that that may be used to provide additional context that the data analysis processor and/or the AI computer system 15 may use to assist in analyzing the user presented research question, the evidence documents 24, and reference materials 26. Upon receiving the user selected information to be used in answering the user presented research question, the data analysis processor may render a confirmation window 40 which displays the user presented research question 36 and the user selected information 42 to be used in answering the user presented research question, and prompts the user to confirm the user selections.

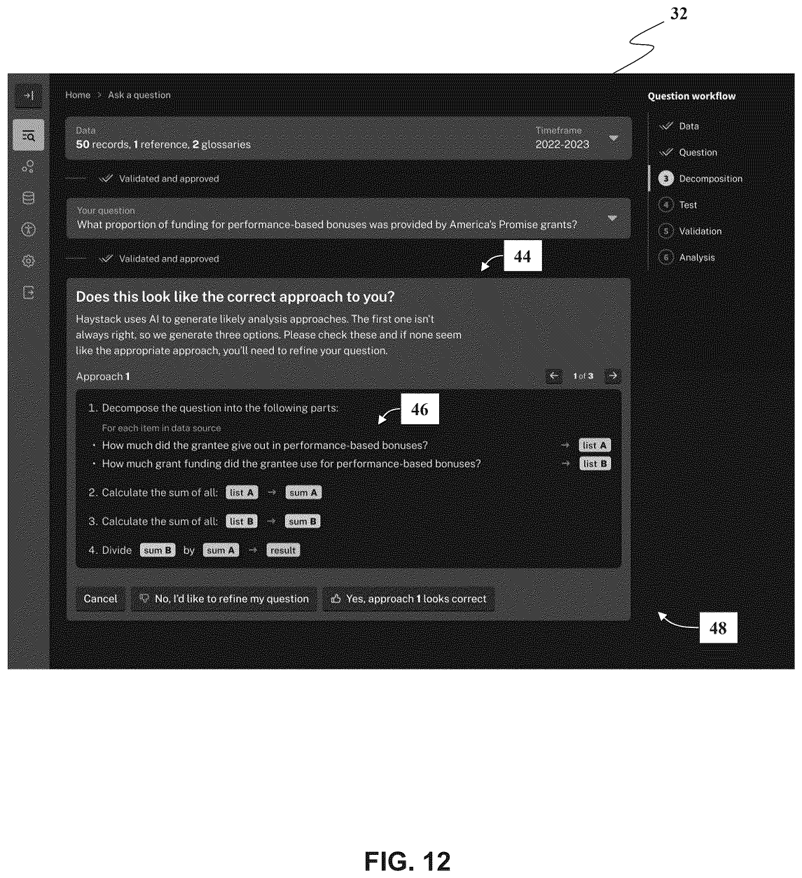

In method step 204, upon receiving the user presented research question via the research question input prompt 34 and the user selected information included in the data source 22, the AI computer system 15 analyzes the received user presented research question and user selected information and establishes an answer approach to respond to the user presented research question. For example, as shown in FIGS. 3 and 12, the data analysis processor may query the AI computer system 15 to establish an answer approach 44 including a question decomposition data structure 45 that includes a plurality of decomposed questions 46 based on the received research question 36, and render a question decomposition window 48 that displays the answer approach including the decomposed questions 46, and prompts the user to confirm the presented answer approach 44. The data analysis processor also allows the user to modify the answer approach 44 via the question decomposition window 48.

In method step 206, upon receiving confirmation of the answer approach 44 from the user, the data analysis processor may then query the AI computer system 15 to determine one or more entry-level answers associated with each decomposed question 46 based on the question decomposition data structure 45. For example, the data analysis processor may query the AI computer system 15 to extract evidence from the plurality of evidence documents included in the data source 22 based on the plurality of decomposed questions 46 and the question decomposition data structure 45, and query the AI computer system 15 to determine one or more entry-level answers associated with each decomposed question 46 based on the extracted evidence from the plurality of evidence documents 24 and the question decomposition data structure 45. The data analysis processor may also query the AI computer system 15 to select one or more evidence documents 24 associated with the one or more entry-level answers.

In method step 208, the data analysis processor generates a reasoning graph data structure 30 (shown in FIGS. 4-7) to assist in generating a final answer 52 to the received research question 36, and to assist a user/analyst in evaluating the responsiveness and accuracy of the final answer 52. For example, in some embodiments, the data analysis processor generates the reasoning graph data structure 30 by determining a corresponding confidence score 58 associated with each entry-level answer 56, and identifying a corresponding evidence document 24 used in generating each entry-level answer 56.

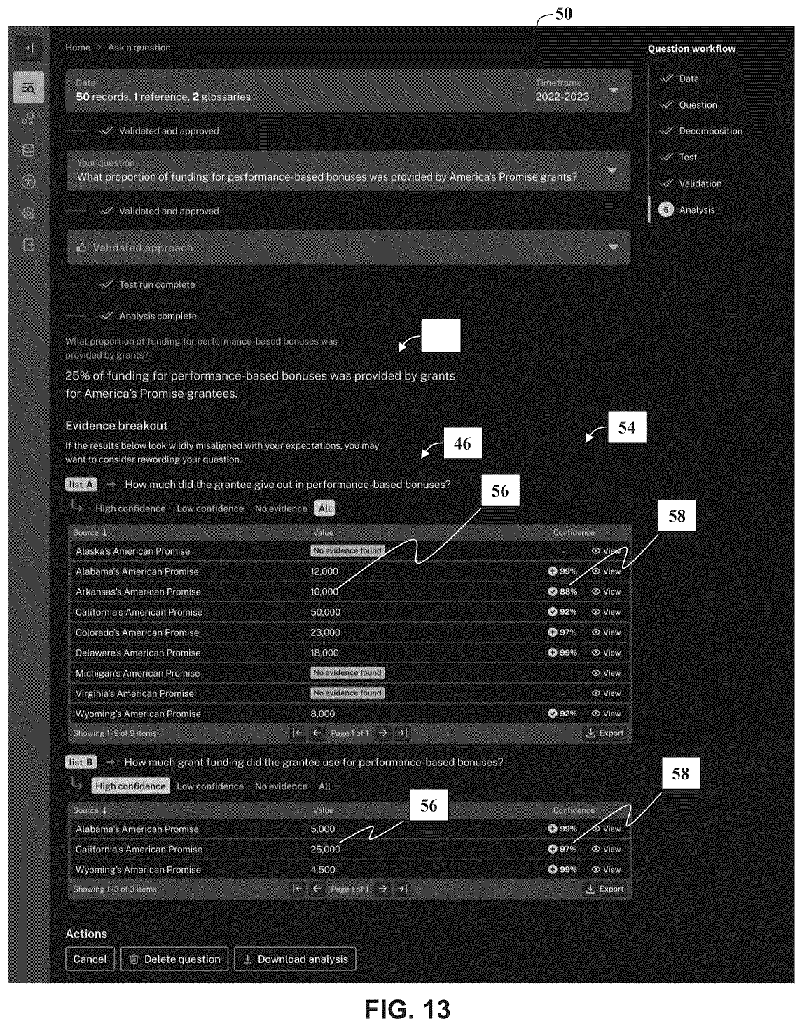

In method step 210, the data analysis processor generates a final answer 52 to the research question 36 based on the reasoning graph data structure 30. As shown in FIG. 13, the data analysis processor may render a data analysis results screen 50 that displays the final answer 52 to the user presented research question 36, and includes an evidence breakout section 54 that displays each entry-level answer 56 associated with each decomposed question 46. In this manner, the data analysis results screen 50 allows the user to evaluate the responsiveness and accuracy of the final answer 52 by viewing and verifying each entry-level answer 56 used in generating the final answer 52.

In method step 212, the data analysis processor renders the data analysis results screen 50 displaying the final answer 52 and the evidence breakout section 54 including the one or more entry-level answers 56, and information included in the reasoning graph data structure 30 including the corresponding confidence score 58 and the corresponding evidence document 24 associated with each entry-level answer 56.

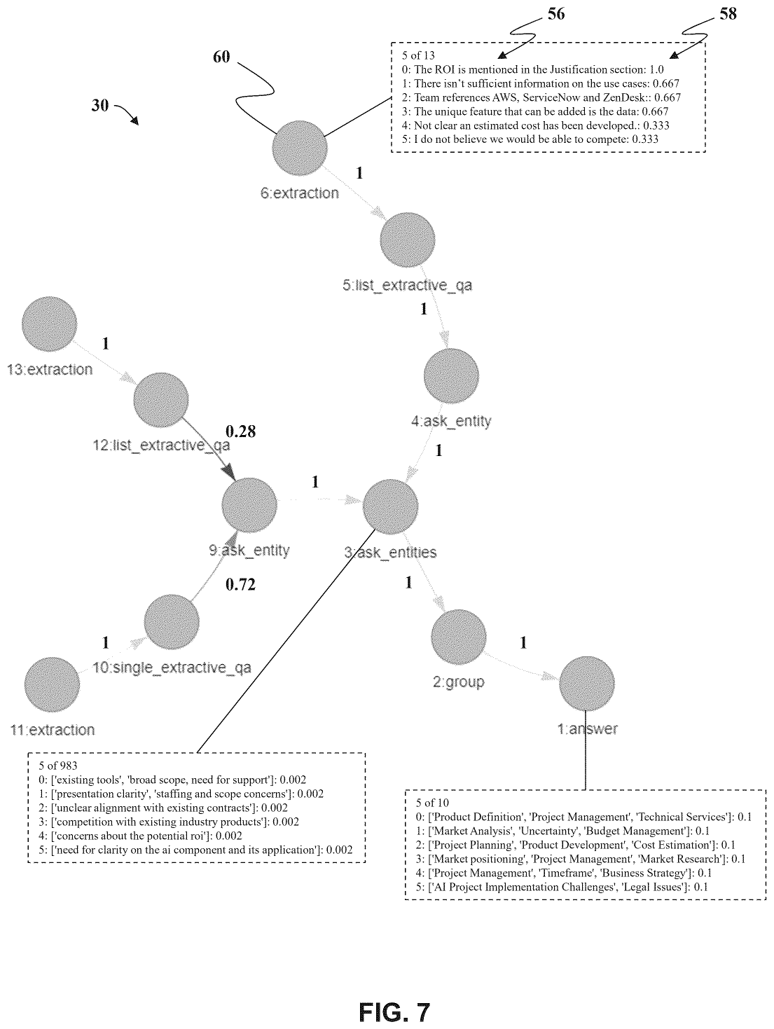

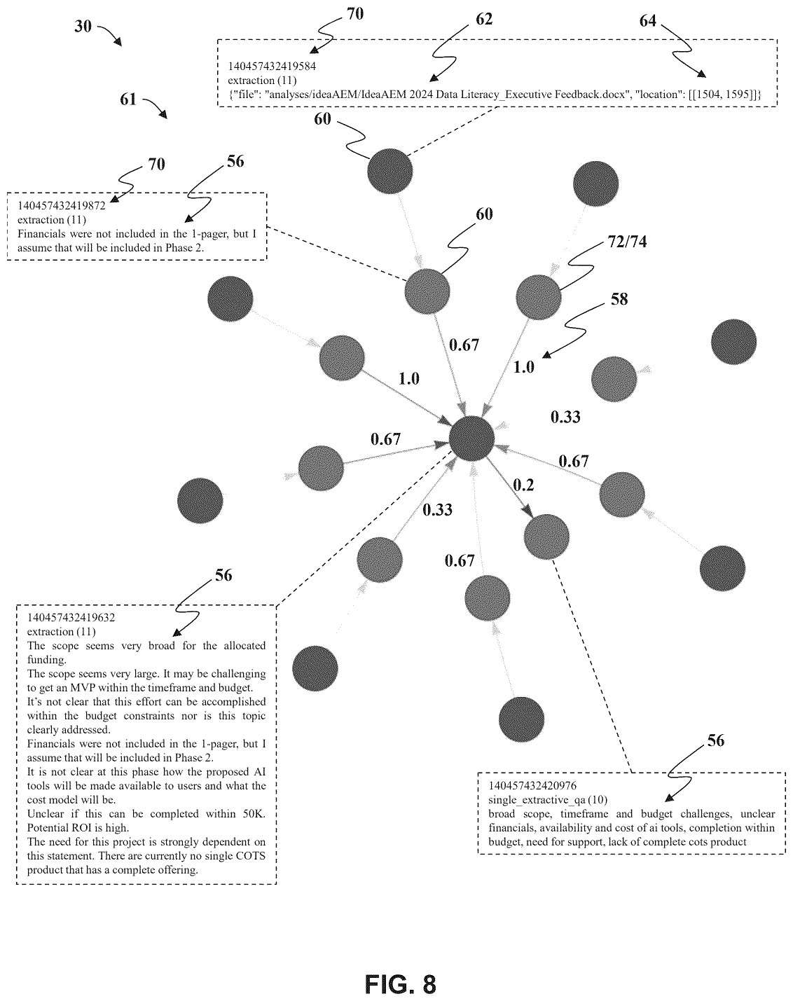

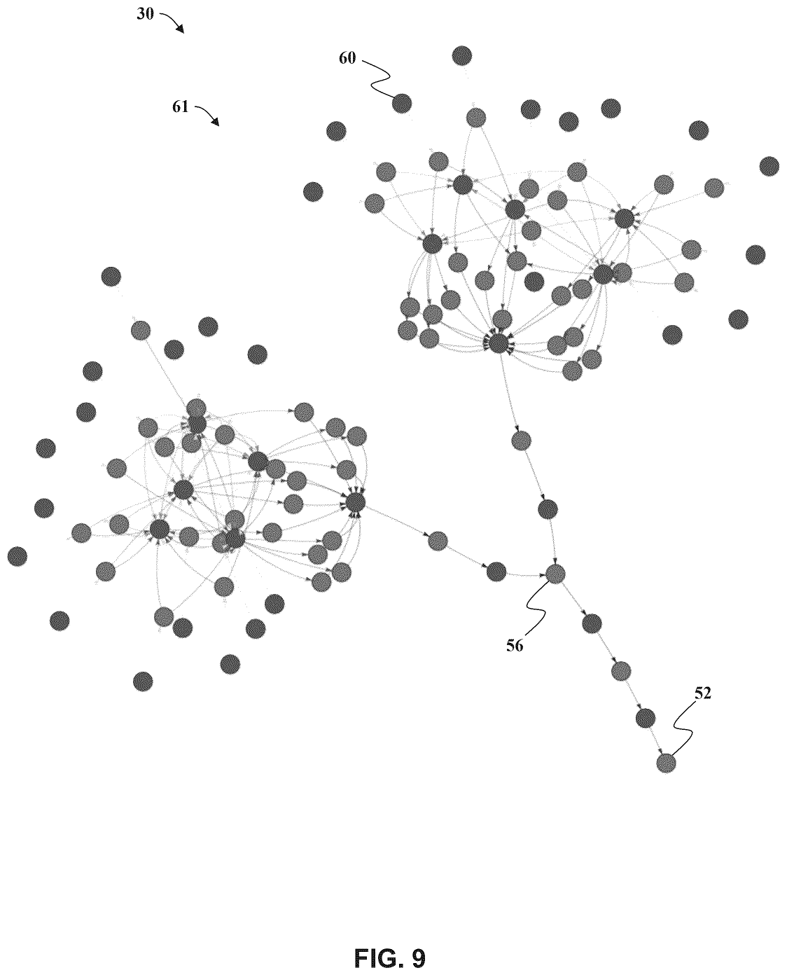

In some embodiments, as shown in FIGS. 7-9, the data analysis processor may be programmed to generate the reasoning graph data structure 30 including a plurality of extraction nodes 60 associated with the one or more entry-level answers 56 indicating evidence data used in generating the one or more entry-level answers 56. For example, the data analysis processor may generate an evidence trace data structure 61 (shown in FIGS. 8 and 9) based on the reasoning graph data structure 30 to include corresponding extraction nodes 60 associated with a corresponding entry-level answer 56. The data analysis processor generates the corresponding extraction nodes 60 by identifying the corresponding evidence document 24 used in determining the corresponding entry-level answer 56 and including a document ID 62 associated with the corresponding evidence document 24. In addition, the data analysis processor may generate the corresponding extraction node by identifying evidence text included in the corresponding evidence document 24 used in determining the corresponding entry-level answer 56 and establishing an evidence location ID 64 associated with identified evidence text. For example, the document ID 62 and evidence location ID may include a Uniform Resource Locator (URL) including the address of the evidence document and evidence text location within the data source 22.

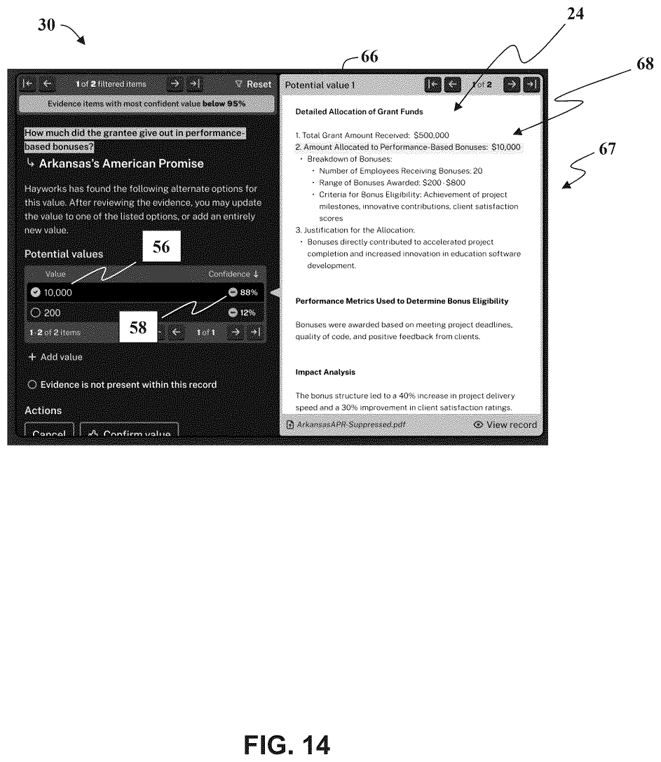

In some embodiments, the data analysis processor may render the data analysis results screen 50 to include each entry-level answer 56 with user selectable icons that prompt the data analysis processor to display evidence information associated with a user selected answer. For example, the data analysis processor may receive an evidence view request from the user via a user selection of an entry-level answer 56 displayed on the data analysis results screen 50 to view evidence information associated with a user selected entry-level answer. The data analysis processor then renders an evidence window 66 (shown in FIGS. 14-16) displaying an evidence trace 67 including the evidence data associated with the user selected entry-level answer 56.

For example, upon receiving the user selected entry-level answer 56, the data analysis processor may query the reasoning graph data structure 30 and/or the evidence trace data structure 61 to identify the corresponding extraction node 60 associated with the user selected entry-level answer 56, query the corresponding extraction node 60 to identify the document ID 62 and the evidence location ID 64, query the data source 22 to retrieve corresponding evidence text 68 based on the document ID 62 and the evidence location ID 64, and render the evidence window 66 displaying the evidence trace 67 including the corresponding evidence text 68. In some embodiments, the data analysis processor may also generate each extraction node 60 including a node ID 70. Upon receiving the user selected entry-level answer 56, the data analysis processor then identifies a corresponding node ID 70 associated with the user selected entry-level answer 56, and queries the reasoning graph data structure 30 to identify the corresponding extraction node 60 associated with the corresponding node ID 70.

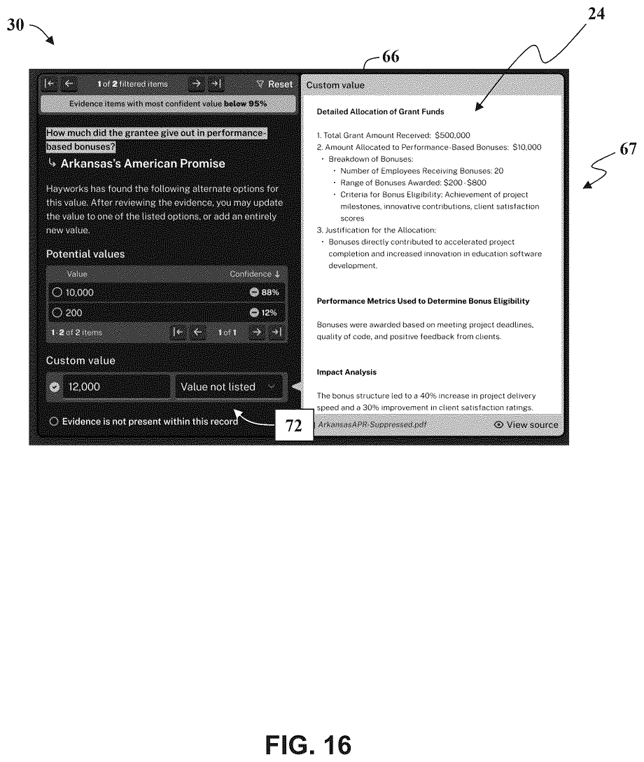

The data analysis processor may also be programmed to render the evidence window 66 including a custom value prompt 72 (shown in FIG. 16) that allows the user to modify a corresponding entry-level answer 56 to include a user defined value. For example, the data analysis processor may receive user modified entry-level answer data 56 via the custom value prompt 72 and modify the final answer 52 based on the user modified entry-level answer data 56. In some embodiments, the data analysis processor also generates a user modified data node 74 associated with the user modified entry-level answer 56 and modifies the reasoning graph data structure 30 to include the user modified data node 74. In this way, the data analysis processor modifies the reasoning graph data structure 30 and/or evidence trace data structure 61 to include user modified values to enable a user to evaluate the changes to the final answer based on the user modified values to improve the accuracy of the final answer 52 provided by the data analysis processor.

For example, FIGS. 7-9 illustrate algorithms executed by the data analysis processor showing a reasoning process (node-by-node) undertaken to answer a question. The operation type is shown below the node, and the contribution of an individual node to a child node is shown next to the corresponding arrows adjacent the nodes. The reasoning process includes: extraction nodes that look at a document and extracts one or more pieces of relevant text; list_extractive_qa nodes that look at the extracted text and produces a list of answers, all of which are regarded as equally correct. For example, a single document is likely to have multiple concerns; single_extractive_qa nodes that look at the extracted text and produces a single answer. If there are multiple answers in the extracted text, one or all of them are wrong. An example question would be what year did this program start?; ask_entity nodes that receive a question and a set of documents, and determine whether it's a single or list question, as well as which document to ask; ask_entities nodes that run ask_entity on multiple entities (in our example, each entity corresponds to a proposal); group nodes that produce themes across the various responses from ask_entities nodes; and an answer node that returns the answer.

FIG. 8 illustrates evidence graph data structures including the chain of reasoning performed by the data analysis processor for a question asked of a single evidence document, with the final answer traced to extracted text and to a specific location in an evidence document. FIG. 9, extends the chain of reasoning shown in FIG. 8 to the full process, including two evidence documents and the final grouping and answer operations, which can trace all the way from the location in a document to the final answer. This ensures that no false information is produced, and the analyst/user can intervene or inspect every decision that is made.

In some embodiments, Question Decomposition may include any sequence to sequence architecture for step-by-step processing including, for example, LLM/Transformer/Attention Model/RNN/LSTM/GRU. Question rephrasing can be done via single-step, bidirectional, or autoregressive sequence-to-sequence architectures.

Ask_Entity may include: Selecting best document can be performed via LLM, vector searches, classical search (e.g., TF-IDF) and others; Selecting output type (list/single) can be performed via any binary classifier (logistic regression, support vector machines based on appropriate embedding space, RNN/LSTM/GRU/Transformer based sequence classifier (as well as LLMs); and/or Database lookup (table selection and query generation)

Individual Questions/Evidence Extraction/QA may include: Keyword extraction methods, CNNs (if images are included), extractive QA methods (including RNNs, LSTMs, GRUs, Transformers), direct answering from a fixed set of words (using any of the above methods); and/or Database lookup for structured data.

Grouping/Clustering may include: Use of numerous clustering algorithms (e.g., K-Means, hierarchical clustering, agglomerative clustering, expectation maximization) for grouping; and/or use of LLMs, keyword classification models, TF-IDF for naming the groups.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, MongoDB™ database engines which is a document storage solution, Oracle® Database, MySQL, IBM® Db2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A networked computer system comprising:
a data storage server storing a data source including information associated with a plurality of evidence documents; and
a data analysis computer server including one or more data analysis processors coupled to the data storage server and to an artificial intelligence (AI) computer system, the one or more data analysis processors programmed to execute an algorithm including the steps of:
rendering a data analysis input screen on a display device of a user computing device, the data analysis input screen including a research question input prompt;
receiving a research question from a user via the research question input prompt;
querying the AI computer system to establish a question decomposition data structure including a plurality of decomposed questions based on the received research question;
querying the AI computer system to extract evidence from the plurality of evidence documents included in the data source based on the plurality of decomposed questions;
querying the AI computer system to determine one or more entry-level answers associated with each decomposed question based on the extracted evidence from the plurality of evidence documents;
querying the AI computer system to select one or more evidence documents associated with the one or more entry-level answers;
generating a reasoning graph data structure by:
determining a corresponding confidence score associated with each entry-level answer; and
identifying a corresponding evidence document used in determining each entry-level answer;
generating a final answer to the research question based on the reasoning graph data structure; and
rendering a data analysis results screen on the display device displaying the final answer, the one or more entry-level answers, and information included in the reasoning graph data structure including the corresponding confidence score and the corresponding evidence document associated with each entry-level answer.

2. The networked computer system of claim 1, wherein the one or more data analysis processors is programmed to execute the algorithm including the steps of:
generating the reasoning graph data structure including a plurality of extraction nodes associated with the one or more entry-level answers indicating evidence data used in generating the one or more entry-level answers.

3. The networked computer system of claim 2, wherein the one or more data analysis processors is programmed to execute the algorithm including the steps of:
generating a corresponding extraction node associated with a corresponding entry-level answer by:
identifying the corresponding evidence document used in determining the corresponding entry-level answer and including a document ID associated with the corresponding evidence document.

4. The networked computer system of claim 3, wherein the one or more data analysis processors is programmed to execute the algorithm including the steps of:
generating the corresponding extraction node by:
identifying evidence text included in the corresponding evidence document used in determining the corresponding entry-level answer and establishing an evidence location ID associated with identified evidence text.

5. The networked computer system of claim 4, wherein the one or more data analysis processors is programmed to execute the algorithm including the steps of:
receiving an evidence view request from the user to view evidence information associated with a user selected entry-level answer; and
rendering an evidence window displaying an evidence trace including the evidence data associated with the user selected entry-level answer.

6. The networked computer system of claim 5, wherein the one or more data analysis processors is programmed to execute the algorithm including the steps of:
querying the reasoning graph data structure to identify the corresponding extraction node associated with the user selected entry-level answer;
querying the corresponding extraction node to identify the document ID and the evidence location ID;
querying the data source to retrieve corresponding evidence text based on the document ID and the evidence location ID; and
rendering the evidence window displaying the evidence trace including corresponding evidence text.

7. The networked computer system of claim 5, wherein the one or more data analysis processors is programmed to execute the algorithm including the steps of:
receiving user modified entry-level answer data via a custom value prompt displayed with the evidence window;
generating a user modified data node associated with the user modified entry-level answer data and modifying the reasoning graph data structure to include the user modified data node; and
modifying the final answer based on the modified reasoning graph data structure.

8. The networked computer system of claim 5, wherein the one or more data analysis processors is programmed to execute the algorithm including the steps of:
generating each extraction node including a node ID; and
upon receiving the user selected entry-level answer, identifying a corresponding node ID associated with the user selected entry-level answer; and
querying the reasoning graph data structure to identify the corresponding extraction node associated with the corresponding node ID.

9. A method of operating a networked computer system including a data storage server storing a data source including information associated with a plurality of evidence documents, and a data analysis computer server including one or more data analysis processors coupled to the data storage server and to an artificial intelligence (AI) computer system, the method including the one or more data analysis processors performing an algorithm including the steps of:
rendering a data analysis input screen on a display device of a user computing device, the data analysis input screen including a research question input prompt;
receiving a research question from a user via the research question input prompt;
querying the AI computer system to establish a question decomposition data structure including a plurality of decomposed questions based on the received research question;
querying the AI computer system to extract evidence from the plurality of evidence documents included in the data source based on the plurality of decomposed questions;
querying the AI computer system to determine one or more entry-level answers associated with each decomposed question based on the extracted evidence from the plurality of evidence documents;
querying the AI computer system to select one or more evidence documents associated with the one or more entry-level answers;
generating a reasoning graph data structure by:
determining a corresponding confidence score associated with each entry-level answer; and
identifying a corresponding evidence document used in determining each entry-level answer;
generating a final answer to the research question based on the reasoning graph data structure; and
rendering a data analysis results screen on the display device displaying the final answer, the one or more entry-level answers, and information included in the reasoning graph data structure including the corresponding confidence score and the corresponding evidence document associated with each entry-level answer.

10. The method of claim 9, including the one or more data analysis processors performing the algorithm including the steps of:
generating the reasoning graph data structure including a plurality of extraction nodes associated with the one or more entry-level answers indicating evidence data used in generating the one or more entry-level answers.

11. The method of claim 10, including the one or more data analysis processors performing the algorithm including the steps of:
generating a corresponding extraction node associated with a corresponding entry-level answer by:
identifying the corresponding evidence document used in determining the corresponding entry-level answer and including a document ID associated with the corresponding evidence document.

12. The method of claim 11, including the one or more data analysis processors performing the algorithm including the steps of:
generating the corresponding extraction node by:
identifying evidence text included in the corresponding evidence document used in determining the corresponding entry-level answer and establishing an evidence location ID associated with identified evidence text.

13. The method of claim 12, including the one or more data analysis processors performing the algorithm including the steps of:
receiving an evidence view request from the user to view evidence information associated with a user selected entry-level answer; and
rendering an evidence window displaying an evidence trace including the evidence data associated with the user selected entry-level answer.

14. The method of claim 13, including the one or more data analysis processors performing the algorithm including the steps of:
querying the reasoning graph data structure to identify the corresponding extraction node associated with the user selected entry-level answer;
querying the corresponding extraction node to identify the document ID and the evidence location ID;
querying the data source to retrieve corresponding evidence text based on the document ID and the evidence location ID; and
rendering the evidence window displaying the evidence trace including the corresponding evidence text.

15. The method of claim 13, including the one or more data analysis processors performing the algorithm including the steps of:
receiving user modified entry-level answer data via a custom value prompt displayed with the evidence window;
generating a user modified data node associated with the user modified entry-level answer data and modifying the reasoning graph data structure to include the user modified data node; and
modifying the final answer based on the modified reasoning graph data structure.

16. The method of claim 13, including the one or more data analysis processors performing the algorithm including the steps of:
generating each extraction node including a node ID; and
upon receiving the user selected entry-level answer, identifying a corresponding node ID associated with the user selected entry-level answer; and
querying the reasoning graph data structure to identify the corresponding extraction node associated with the corresponding node ID.

17. A non-transitory computer-readable storage media having computer-executable instructions embodied thereon to operate a networked computer system including a data storage server storing a data source including information associated with a plurality of evidence documents, and a data analysis computer server including one or more data analysis processors coupled to the data storage server and to an artificial intelligence (AI) computer system, when executed by the one or more data analysis processors the computer-executable instructions cause the one or more data analysis processors to perform an algorithm including the steps of:
rendering a data analysis input screen on a display device of a user computing device, the data analysis input screen including a research question input prompt;
receiving a research question from a user via the research question input prompt;
querying the AI computer system to establish a question decomposition data structure including a plurality of decomposed questions based on the received research question;
querying the AI computer system to extract evidence from the plurality of evidence documents included in the data source based on the plurality of decomposed questions;
querying the AI computer system to determine one or more entry-level answers associated with each decomposed question based on the extracted evidence from the plurality of evidence documents;
querying the AI computer system to select one or more evidence documents associated with the one or more entry-level answers;
generating a reasoning graph data structure by:
determining a corresponding confidence score associated with each entry-level answer; and
identifying a corresponding evidence document used in determining each entry-level answer;
generating a final answer to the research question based on the reasoning graph data structure; and
rendering a data analysis results screen on the display device displaying the final answer, the one or more entry-level answers, and information included in the reasoning graph data structure including the corresponding confidence score and the corresponding evidence document associated with each entry-level answer.

18. The non-transitory computer-readable storage media of claim 17, wherein the computer-executable instructions cause the one or more data analysis processors to perform the algorithm including the steps of:
generating the reasoning graph data structure including a plurality of extraction nodes associated with the one or more entry-level answers indicating evidence data used in generating the one or more entry-level answers.

19. The non-transitory computer-readable storage media of claim 18, wherein the computer-executable instructions cause the one or more data analysis processors to perform the algorithm including the steps of:
generating a corresponding extraction node associated with a corresponding entry-level answer by:
identifying the corresponding evidence document used in determining the corresponding entry-level answer and including a document ID associated with the corresponding evidence document; and
identifying evidence text included in the corresponding evidence document used in determining the corresponding entry-level answer and establishing an evidence location ID associated with identified evidence text.

20. The non-transitory computer-readable storage media of claim 19, wherein the computer-executable instructions cause the one or more data analysis processors to perform the algorithm including the steps of:
receiving an evidence view request from the user to view evidence information associated with a user selected entry-level answer;
querying the reasoning graph data structure to identify the corresponding extraction node associated with the user selected entry-level answer;
querying the corresponding extraction node to identify the document ID and the evidence location ID;
querying the data source to retrieve corresponding evidence text based on the document ID and the evidence location ID; and
rendering an evidence window displaying an evidence trace including the corresponding evidence text associated with the user selected entry-level answer.
